(19) United States
(12) Patent Application Publication
(10) Pub. No.: US 2004/0044535 A1
(43) Pub. Date: Mar. 4, 2004

(54) Systems and methods for a digital information automated teller machine

(76) Inventors: Erin L. Conner, Rochester, NY (US); James Pascucci, Williamson, NY (US); Amy Jo Naylor, Jasper, NY (US)

Correspondence Address: OLIFF & BERRIDGE, PLC., P.O. BOX 19928, ALEXANDRIA, VA, 22320, US

(21) Appl. No.: 10/064,950

(22) Filed: Sep. 3, 2002

(51) Int. Cl. G06F 17/60

(52) U.S. Cl. 705/1; 705/40

(57) ABSTRACT

Systems and methods for implementing a retail transaction at a digital information ATM are disclosed. Paper and blank electronic media may be purchased at the ATM. The electronic media includes CD-ROMs, DVD-ROMs and floppy disks. A computer file may be transferred to the storage media as part of the transaction. The file may be transferred from any external electronic media. Thus, the file may be transferred from a remote computer accessible via the internet. Alternately, the file may be transferred from any storage media controlled by a portable digital device, such as a digital camera, a cell phone, a portable computer or a PDA. Alternately, the file may be transferred from a remote storage device accessible via the Internet to either media sold at or external to and in communication with the digital information ATM.

### BACKGROUND OF THE INVENTION

1. Field of Invention

This invention generally relates to systems and methods for transferring information between storage media in a retail transaction.

2. Description of Related Art

Portable electronic devices commonly collect and transfer digital information. For example, digital telephones and portable computers are able to collect digital information from the Internet. Digital cameras capture images onto electronic media.

Moreover, important information is commonly transmitted between remote sites and/or devices via a network, such as the Internet.

### SUMMARY OF THE INVENTION

As outlined above, portable digital devices commonly collect and transfer digital information. With the advent of portable digital devices, the need for memory has become a substantial issue for users of these devices. For example, these devices generally lack the memory required to process large files, and/or are unable to display the information contained in these files.

The limitations of memory often necessitate the time-consuming task of downloading the information stored on these devices to a separate computer, or purchasing expensive additional memory cards and RAM for these devices.

Moreover, digital information often cannot be processed by the portable electronic device. Therefore, a user generally needs a way to transfer files to a remote location via a network, such as the Internet.

This invention provides systems and methods that transfer files between storage media.

This invention provides systems and methods that transfer a computer file to and/or from a portable digital device to electronic media and/or paper.

This invention provides systems and methods that transfers a data file to and/or from storage media at a remote location accessible via a network.

This invention additionally provides systems and methods that enable the purchase of storage media.

This invention further provides systems and methods that enable the purchase of storage media containing a computer file transferred from other media.

In various exemplary embodiments according to this invention, a digital information automatic teller machine (ATM) charges a transaction fee for a retail transaction. In various exemplary embodiments, blank media is purchasable at the digital information ATM. The media may be electronic media, for example, CD-ROM, DVD-ROM, or floppy disks. Alternately, the media may be paper. The blank media may be purchased in any retail quantity.

In various exemplary embodiments, the transaction involves the transfer of data from a first storage media to a second storage media. In various exemplary embodiments, the first storage media is within and/or controlled by and in communication with the portable digital device. The ATM establishes a communication link with the portable digital device using any appropriate communication structure. In still other exemplary embodiments, the first storage media is a CD-ROM, a DVD-ROM, and/or a floppy disk and/or any other appropriate information carrying structure, device or material that is external to the digital information ATM.

In various exemplary embodiments, the second storage media is media sold at the digital information ATM. In various exemplary embodiments, the second storage media is a CD-ROM disk, a DVD-ROM disk, a floppy disk, and/or a sheet of paper or other visible information bearing media, and/or any other appropriate information carrying structure, device or material.

In various exemplary embodiments, the second storage media is controlled by a remote computer in communication with the digital information ATM along a network. In various exemplary embodiments, the network is the Internet.

In still other exemplary embodiments, the first storage media is controlled by a remote computer in communication with the digital information ATM via a network.

These and other features and advantages of this invention are described in or apparent from the following detailed description of the apparatus/systems and methods according to this invention.

### BRIEF DESCRIPTION OF THE DRAWINGS

Various exemplary embodiments of this invention will be described in detail, with reference to the following figures, wherein:

FIG. 1 shows an exterior view of one exemplary embodiment of a digital information ATM according to this invention;

FIG. 2 is a block diagram showing one exemplary embodiment of a digital information ATM system according to this invention;

FIG. 3 is a block diagram showing one exemplary embodiment of the electronic media distribution device of FIG. 2 according to this invention;

FIG. 4 is a first exemplary embodiment of a selection apparatus usable to select a transaction type;

FIG. 5 is a first exemplary embodiment of a selection apparatus usable to select a media type;

FIG. 6 is a first exemplary embodiment of a selection apparatus usable to select a payment type;

FIG. 7 is a flowchart outlining a first exemplary embodiment of a method of operation of a digital information ATM according to this invention;

FIG. 8 is a flowchart outlining in greater detail one exemplary embodiment of the method for determining a media type of FIG. 7;

FIG. 9 is a flowchart outlining in greater detail one exemplary embodiment of the method for processing a payment of FIG. 7;

FIG. 10 is a flowchart outlining a second exemplary embodiment of a method of operation of a digital information ATM according to this invention;

FIG. 11 is a flowchart outlining in greater detail one exemplary embodiment of the method for uploading data from external electronic media into memory of FIG. 10;

FIG. 12 is a flowchart outlining in greater detail one exemplary embodiment of the method for downloading data to media from memory of FIG. 10; and

FIG. 13 is a flowchart outlining in greater detail one exemplary embodiment of the method for determining a remote address accessible from a network of FIG. 10.

### DETAILED DESCRIPTION OF EXEMPLARY EMBODIMENTS

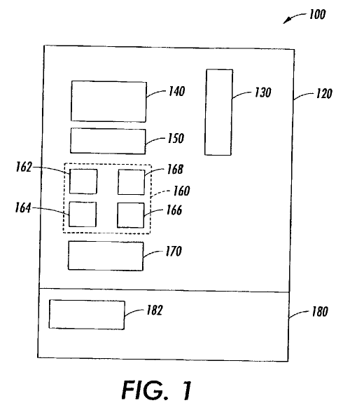

FIG. 1 illustrates an exterior view of an exemplary embodiment of a digital information ATM 100 in accordance with the invention. As shown in FIG. 1, the digital information ATM 100 includes a digital media section 120 and a digital photocopier section 180. The digital photocopier section 180 comprises a sheet media dispenser 182. The sheet media dispenser 182 provides an area at which a user of the digital information ATM may receive hard copies of computer files printed on one or more pages of the sheet media or blank pages of the sheet media. The blank pages of the sheet media may be sold in any desired retail quantity.

The digital media section 120 enables a user to operate the digital information ATM 100. The digital media section 120 includes a keyboard 150 and/or any other appropriate data input device and a monitor 140. The monitor 140 may be a touch screen monitor enabling the user to make selections directly on the screen. The digital media section 120 also includes a data input apparatus 160 that the user can use to input electronic data into the ATM 100. The data input apparatus 160 can include any or all of a CD-ROM drive 162, a DVD-ROM drive 164, a floppy disk drive 166, and an external media port 168, as well as any other known or later developed device usable to input data from any known or later-developed electronic data storage device. The external media port 168 enables the digital information ATM 100 to directly electronically connect an external device, such as a laptop computer, a digital camera, a cell phone, a Personal Digital Assistant (PDA), or any other known or later-developed electronic device that is able to store, generate and/or transmit electronic data. The external media port may include an Universal Serial Bus (USB) port, a radio-frequency (RF) port, an infrared (IR) port, an RS-232 port or any other known or later-developed port usable to communicate electronic data from an external device to the digital information ATM 100.

The digital media section 120 also includes an electronic media dispenser 170, by which a user of the digital information ATM 100 may receive one or more blank or information carrying pieces of electronic media. The user may purchase any form of electronic media, such as CDs, DVDs, or floppy disks. Moreover, in various exemplary embodiments, the digital information ATM 100 may dispense electronic media from the CD-ROM drive 162, the DVD-ROM drive 164, or the floppy disk drive 166.

In various exemplary embodiments, the digital media section includes a payment center 130. The user of the digital information ATM 100 pays for the user's purchases of products and services via the payment center 130. In various exemplary embodiments, the payment center 130 accepts cash, credit cards, ATM cards and/or debit cards or other appropriate known or later-developed payment devices.

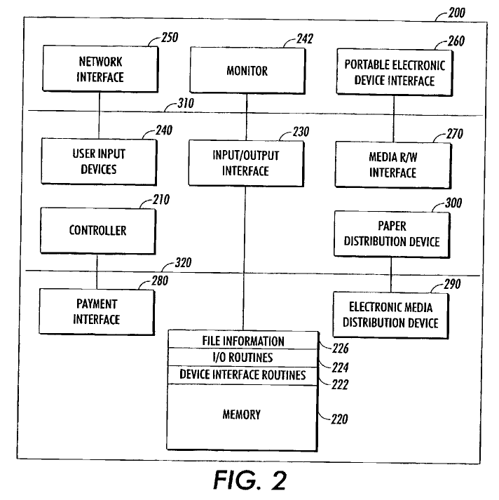

FIG. 2 is a block diagram illustrating a first exemplary embodiment of a system 200 for the digital information ATM 100 according to the invention. As shown in FIG. 2, the digital information ATM system 200 includes an input/output interface 230, a controller 210, a memory 220, a network interface 250, a portable electronic device interface 260, one or more user input devices 240, one or more user display devices 242, a media read/write interface 270, a payment interface 280, a sheet media distribution device 300, and an electronic media distribution device 290. The input/output interface 230, the one or more user input devices 240, the one or more user display devices 242, the network interface 250, the portable electronic device interface 260 and media read/write interface 270 are interconnected by one or more data/control buses or application programming interfaces 310. The controller 210, the memory 220, the payment interface 280, the electronic media distribution device 290 and the sheet media distribution device 300 are interconnected by one or more data/control buses or application programming interfaces 320.

The input/output interface 230 inputs data from the one or more user input devices 240, the network interface 250, the portable electronic device interface 260, and the media read/write interface 270 and outputs data to the controller 210. The input/output interface 230 also outputs data to the one or more user display devices 242, the network interface 250, the portable electronic device interface 260 and the media read/write interface 270, the memory 220, and receives data from the controller 210.

The digital information ATM 100 may interact with a remote server via any network communication protocol. Thus, electronic data may be transferred via http or ftp. Moreover, electronic data may be e-mailed to a recipient's location, or downloaded from a user's e-mail mailbox.

The memory 220 includes one or more of an electronic data information portion 226, an input/output routine portion 224, and a device interface routine portion 222. The electronic data information portion 226 stores electronic data to be transferred between media formats and between media and the Internet. The input/output routine portion 224 and the device interface routine section 222 store one or more control routines used by the controller 210 to operate the digital information ATM system 200.

The memory 220 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writeable or rewriteable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

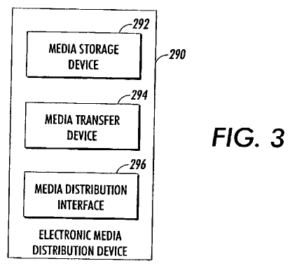

FIG. 3 illustrates a first exemplary embodiment of an electronic media distribution device 290 of the digital information ATM 200. The device 290 comprises a media storage device 292, a media transfer device 294, and a media distribution interface 296. The media storage device 292-stores both packaged quantities of electronic media and individual pieces of electronic media. This electronic media includes floppy disks, CD-ROMs, DVD-ROMs and/or any other known or later-developed electronic media. The media distribution interface 296 enables a user of the digital information ATM 200 to collect the media that has been purchased. In various exemplary embodiments, the media distribution interface 296 also enables the user to insert external electronic media into the digital information ATM 200. The media transfer device 294 transfers media from the media storage device 292 to the media distribution interface 296. In various exemplary embodiments, the media transfer device 294 also transfers media from the media distribution interface 296 to one or more of the CD-ROM drive 262, the DVD-ROM drive 269, the floppy disk drive 266, or any other implemented known or later developed device usable to interface with a electronic data storage device.

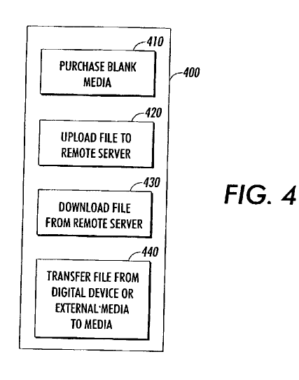

FIG. 4 illustrates a first exemplary embodiment of a selection apparatus 400 usable to select a transaction type available at a digital information ATM 100 using the ATM system 200. The selection device 400 may be, for example, a touch screen or a display device displaying a graphical user interface, a series of buttons or any other known or later-developed device usable to select a desired type of transaction. The selection apparatus 400 includes a “purchase blank media” selection portion 410, an “upload a file to remote server” selection portion 420, a “download a file from remote server” selection portion 430, and a “transfer a file from digital device to alternate media” selection portion 440. Thus, a user of the digital information ATM 100 may purchase blank electronic media or paper, in any desired quantity. Moreover, the user of the digital information ATM 100 has the choice of uploading a file to a remote server, downloading a file from a remote server via the network interface 250, or transferring a file from any media format or external digital device to any media format supported by the digital information ATM 100. Thus, for example, a user may transfer data from a CD-ROM via the digital information ATM 100 to a DVD-ROM. The user may alternatively transfer data from a digital camera via the portable electronic device interface 260 to any digital media supported by the digital information ATM 100. The user may also transfer any information able to be represented visually to hard copy via the sheet media distribution device 300.

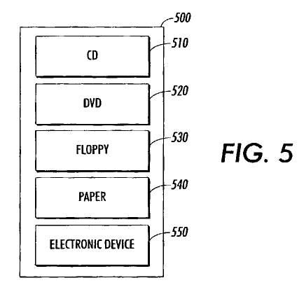

FIG. 5 illustrates a first exemplary embodiment of a selection apparatus 500 usable to select a media type from the media types available at the digital information ATM 100. The media selection apparatus 500 includes a CD-ROM selection portion 510, a DVD-ROM selection portion 520, a floppy disk selection portion 530, a sheet media selection portion 540, and an electronic device selection portion 550.

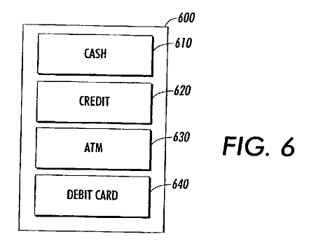

FIG. 6 illustrates a first exemplary embodiment of a selection apparatus 600 usable to select a payment type in accordance with the invention. The payment selection apparatus 600 includes a cash selection portion 610, a credit card selection portion 620, an ATM card selection portion 630, and a debit card selection portion 640. In various exemplary embodiments, a user may purchase a digital information ATM debit card that is usable only at digital information ATMs.

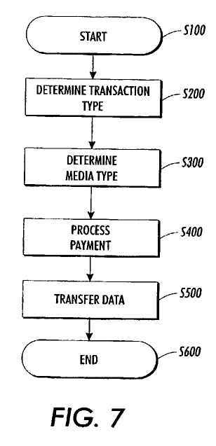

FIG. 7 is a flowchart outlining a first exemplary embodiment of a method for operating a digital information ATM according to this invention. As shown in FIG. 7, operation of the method begins in step S100, and continues to step S200, where a transaction type is determined. Various exemplary transaction types were identified in FIG. 4. Then, in step S300, a media type is determined using the exemplary media identified in FIG. 5. Next, in step S400, payment for the purchase is processed using the exemplary payment types identified in FIG. 6. Then, in step S500, data is transferred from an external electronic device or digital media to an internal media type or Internet. Operation then continues to step S600, where operation of the method ends.

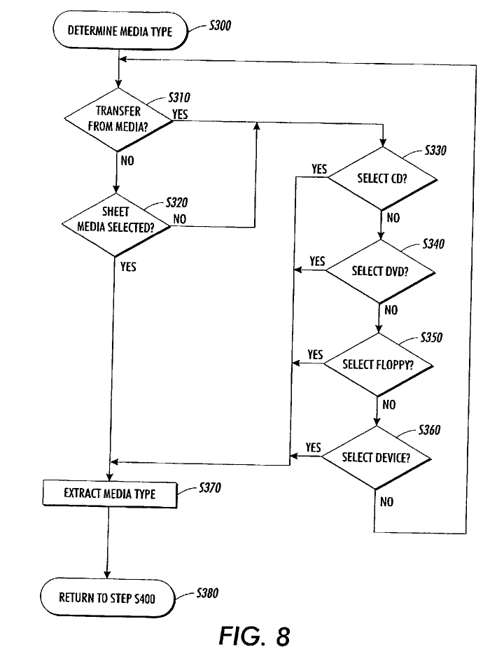

FIG. 8 is a flowchart outlining in greater detail one exemplary embodiment of the method for determining the media type of FIG. 7. As shown in FIG. 8, operation of the method begins in step S300, and continues to step S310, where a determination is made whether the user is transferring data from external media. If the user is not transferring data from an external media, then operation continues to step S320. Otherwise operation jumps to step S330.

In step S320, a determination is made whether the user has selected sheet media as the source of the data. If the user has selected sheet media, operation jumps to step S370. Otherwise operation continues to step S330. In step S330, a determination is made whether the user has selected a CD-ROM as the source of the data. If not, then processing continues to step S340. Otherwise, operation jumps to step S370. In step S340, a determination is made whether the user has selected a DVD-ROM as the source of the data. If not, then processing continues to step S350. Otherwise, operation jumps to step S370. In step S350, a determination is made whether the user has selected a floppy disk as the source of the data. If not, then processing continues to step S360. Otherwise, operation jumps to step S370. In step S360, a determination is made whether the user has selected an external electronic device as the source of the data. The external device may be any data processing or data capturing device that stores information on digital media. Thus, the device may be a digital camera, a PDA, a cell phone, a portable computer or any other known or later-developed appropriate device. If not, then no selection has been made by the user. In this case, operation returns to step S310. Otherwise, operation continues to step S370.

In step S370, the selected media type is extracted based on the selection made by the user. Operation then continues to step S380, where operation of the method returns to step S400.

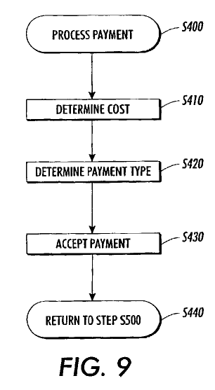

FIG. 9 is a flowchart outlining in greater detail one exemplary embodiment of the method for processing a payment of FIG. 7. As shown in FIG. 9, operation of the method begins in step S400, and continues to step S410, where the cost of the transaction is determined. The cost of the transaction is based on the cost of the media plus the cost of any Internet fee plus any transaction costs and standard ATM charges. The Internet usage charge may be time-based or based on a per-use basis. Then, in step S420, the payment type is determined. As discussed in relation to FIG. 6, in various exemplary embodiments, payment may be made by cash, credit card, ATM card, debit card or any other appropriate payment method. Next, in step S430, payment for the digital information ATM transaction is accepted. Then, in step S440, operation of the method returns to step S500.

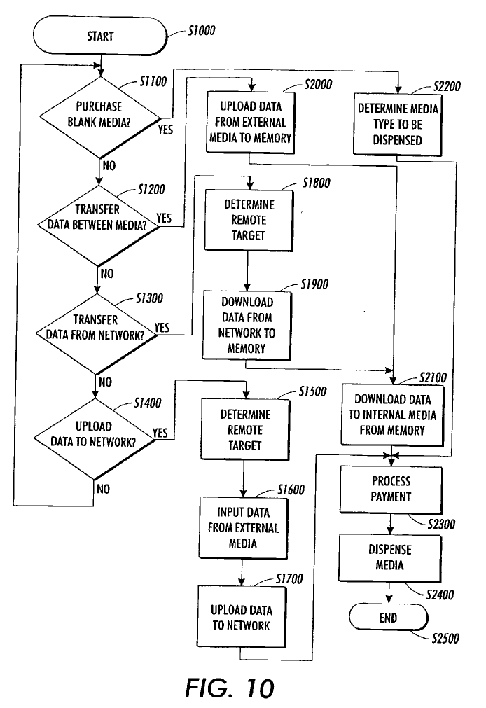

FIG. 10 is a flowchart outlining a second exemplary embodiment of a method for operating a digital information ATM according to this invention. As shown in FIG. 10, operation of the method begins in step S1000, and continues to step S1100, where a determination is made whether the user of the digital information ATM is purchasing blank media. If so, operation jumps to step S2200. Otherwise, operation continues to step S1200.

In step S1200, a determination is made whether the user is transferring data between media or a portable electronic device. If so, operation jumps to step S2000. Otherwise, operation continues to step S1300.

In step S1300, a determination is made whether the user is transferring data from a remote server. If so, then processing jumps to step S1800. Otherwise, operation continues to step S1400.

In step S1400, a determination is made whether data is to be uploaded to a remote target via a network. If not, operation returns to step S1100. Otherwise operation continues to step S1500. In step S1500, a remote target is determined. Next, in step S1600, the data is input from the external media or the portable digital device. Then, in step S1700, the input data is uploaded to the remote location determined in step S1500.

In step 1800, a remote target is determined. Next, in step S1900, data is downloaded from the remote location determined in step S1800 to memory. Then, operation of the method continues to step S2100.

In step S2000, data is uploaded from the external media to memory. The data may be in the form of one or more electronic files. Operation continues to step S2100.

In step S2100, data is transferred to internal media from internal memory. Operation of the method continues to step S2300.

In step S2200, a media type to be dispensed is determined. Operation of the method continues to step S2300.

In step S2300, payment for the transaction is processed. Next, in step S2400, any media purchased in the transaction is dispensed. Then, in step S2500, operation of the method ends.

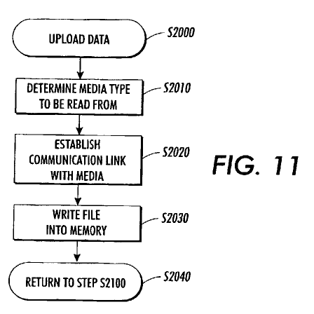

FIG. 11 is a flowchart outlining in greater detail one exemplary embodiment of a method for uploading data from an external media or device according to the invention. As shown in FIG. 11, operation of the method begins in step S2000, and continues to step S2010, where the media type to be read from is determined. The media may be determined by user input, or may be determined automatically when electronic media is inserted into the digital information ATM. The communication link may be established using any protocols well known in the art. Next, in step S2020, a communication link is established with the determined media. Next, in step S2030, the data on the determined media is read from the external media. Then, in step S2040, operation of the method returns to step S2100.

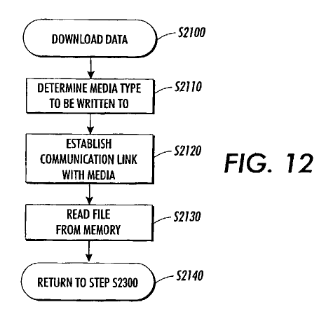

FIG. 12 is a flowchart outlining in greater detail one exemplary embodiment of a method for downloading data to electronic or sheet media. As shown in FIG. 12, operation of the method begins in step S2100, and continues to step S2110, where the media type to receive the data is determined. Next, in step S2120, a communication link with the determined media is established. Next, in step S2130, the data is output to the media determined in step S2110. Then, in step S2140, operation of the method returns to step S2200.

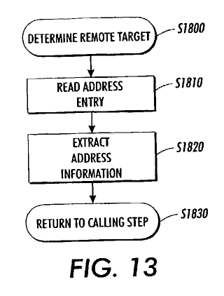

FIG. 13 is a flowchart outlining in greater detail one exemplary embodiment of a method for determining a remote target on a network according to this invention. As shown in FIG. 13, operation of the method begins in step S1800, and continues to step S1810, where an address entry is input. The address entry may correspond to an e-mail address, an IP address, or any other known or later-developed network address. In fact, the address may be any identifier for a computer accessible via the network. Next, in step S1820, the address information is extracted. Then, in step S1830, operation of the method returns to step S1900.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to illustrative, not limiting. Various changes may be made without departing from the spirit and scope of the invention.

What is claimed is:

1. A method of transferring a computer file from a first storage media to a second storage media, comprising:
reading the file from the first storage media into a third storage media;
writing the file from the third storage media into the second storage media; and
charging a transaction fee.

2. The method of claim 1, wherein the second storage media is paper.

3. The method of claim 1, further comprising:
establishing a communication link to a portable electronic device, wherein the first storage media is controlled by the portable electronic device and is in communication with the third storage media through the communication link.

4. The method of claim 2, wherein the communication link is established through an IR port, an USB port, or a RS-232 port.

5. The method of claim 4, further comprising:
establishing a communication link over a computer network to a remote computer, wherein the second storage media is controlled by the remote computer and is in communication with the third storage media over the computer network.

6. The method of claim 5, wherein the computer network is the internet.

7. The method of claim 1, further comprising:
establishing a communication link over a computer network to a remote computer, wherein the first storage media is controlled by the remote computer and is in communication with the third storage media over the computer network.

8. The method of claim 7, wherein the computer network is the internet.

9. The method of claim 8, further comprising:
establishing a communication link to a portable electronic device, wherein the second storage media is controlled by the portable electronic device and is in communication with the third storage media through the communication link.

10. The method of claim 9, wherein the communication link is established via an IR port, an USB port, or a RS-232 port.

11. The method of claim 1, further comprising:
determining a transaction type, wherein the first storage media and the second storage media are identified according to the determined transaction type.

12. A method of purchasing a first storage media from a vending machine, comprising:
selecting a first storage media type;
selecting a first storage media amount;
charging a transaction fee; and
dispensing the first storage media.

13. The method of claim 12, wherein the first storage media is paper, CD-ROM, DVD-ROM, or floppy disk.

14. The method of claim 12, further comprising:
transferring a computer file from a second storage media to the first storage media before the step of dispensing the first storage media.

15. The method of claim 14, further comprising:
establishing a communication link to a portable electronic device, wherein the second storage media is controlled by the portable electronic device and is in communication with the first storage media via the communication link.

16. The method of claim 15, wherein the communication link is established via an IR port, an USB port, or a IR-232 port.

17. The method of claim 14, further comprising:
establishing a communication link over a computer network to a remote computer, wherein the second storage media is controlled by the remote computer and is in communication with the first storage media over the computer network.

18. The method of claim 17, wherein the computer network is the internet.

19. A system for purchasing a first storage media from a vending machine, the system comprising:
a payment interface;
a media distribution device for dispensing the first storage media; and
a user input device for selecting one or more of a media type and a media amount.

20. The system of claim 19, wherein the first storage media is paper and the media distribution device is a digital photocopier.

21. The system of claim 19, wherein the media distribution device is an electronic media distribution device, and the first storage media is electronic storage media.

22. A system for transferring a computer file from a first storage media, the system comprising:
a second media distribution device for distributing a second storage media;
a first media read/write interface for coupling to the first storage media; and
a payment interface for accepting payment for a transaction in which the computer file is transferred from the first storage media to the second storage media.

23. The system of claim 22, wherein the second storage media is paper and the second media distribution device is a digital photocopier.

24. The system of claim 22, wherein the second media is portable electronic media and the second media distribution device is an electronic media distribution device.

25. The system of claim 22, further comprising:
a portable electronic device interface, wherein the portable electronic device interface is in communication with the first storage media and wherein the first storage media is controlled by a portable electronic device.
